(19) United States
(12) Patent Application Publication
(10) Pub. No.: US 2025/0250060 A1
(43) Pub. Date: Aug. 7, 2025

(54) PALLET MOUNTING GPS RECEIVER ATTACHMENT

(71) Applicant: SEIKO EPSON CORPORATION, Tokyo (JP)

(72) Inventor: Yoshihiro YOSHIMURA, MATSUMOTO-SHI (JP)

(73) Assignee: SEIKO EPSON CORPORATION, Tokyo (JP)

(21) Appl. No.: 19/045,485

(22) Filed: Feb. 4, 2025

(30) Foreign Application Priority Data
Feb. 6, 2024 (JP) 2024-016511

(51) Int. Cl. B65D 19/38; G01S 19/14

(52) U.S. Cl. CPC B65D 19/38; G01S 19/14

(57) ABSTRACT

A housing member configured to house a GPS receiver configured to locate, based on a signal from a satellite, a position of a pallet including a mounting surface for mounting a load is provided. The housing member is inserted to a mounting hole of the mounting surface of the pallet from one side in a first direction, so as to set a position of the GPS receiver with respect to the pallet in a second direction intersecting the first direction, and in a third direction intersecting the first direction and second direction. The housing member includes an upper wall intersecting the first direction and including an opening, and a lower wall disposed to face the first surface. The lower wall intersects the first direction and includes an opening.

The present application is based on, and claims priority from JP Application Serial Number 2024-016511, filed Feb. 6, 2024, the disclosure of which is hereby incorporated by reference herein in its entirety.

### BACKGROUND

### 1. Technical Field

The present disclosure relates to a pallet mounting GPS receiver attachment.

### 2. Related Art

In the related art, a technique is known to manage logistics by collecting location information of pallets moving from place to place with GPS receivers installed in pallets used in logistics. The pallet employs a housing cover (attachment) for attaching the GPS receiver to the pallet (see, for example, JP-A-2018-047932). Such pallets may be placed outdoors and exposed to wind and rain for a long period of time, and have a structure to drain water if water enters the attachment attached to the pallet. This prevents the signal intensity of the satellites received by the GPS receiver from being reduced by the water accumulated inside the attachment.

The GPS receiver housing cover (attachment) disclosed in JP-A-2018-047932, however, does not include a water drain structure in the main body and top plate of the housing cover, and as such the water entered the housing cover cannot drain. Therefore, the intensity of the satellite signal received by the terminal apparatus (GPS receiver) may possibly be reduced due to the influence of the water accumulated inside the housing cover and the like, which has been a room for improvement.

### SUMMARY

A pallet mounting GPS receiver attachment according to one aspect of the present disclosure includes a housing member configured to house a GPS receiver configured to locate a position of a pallet based on a signal from a satellite, the pallet including a mounting surface for mounting a load, in which the housing member is inserted to a hole of the mounting surface of the pallet from one side toward the other side in a first direction, and sets a position of the GPS receiver with respect to the pallet in a second direction intersecting the first direction and in a third direction intersecting the first direction and the second direction, and the housing member includes a first surface intersecting the first direction and includes a first opening, and a second surface disposed on a side opposite to the first surface in the first direction, the second surface intersecting the first direction and including a second opening.

### BRIEF DESCRIPTION OF THE DRAWINGS

FIG. 1 is a perspective view illustrating a state before a pallet mounting GPS receiver attachment according to an embodiment of the present disclosure is mounted to a pallet.

FIG. 2 is an enlarged view of a main part illustrated in FIG. 1, and is a perspective view illustrating a state before a housing structure is inserted to a mounting hole of the pallet.

FIG. 3 is a plan view illustrating a configuration of the bottom surface of the pallet.

FIG. 4 is a top plan view illustrating the attachment mounted to the pallet.

FIG. 5 is a perspective view of the attachment as viewed from a first housing member side.

FIG. 6 is an exploded perspective view of the housing structure.

FIG. 7 is an exploded perspective view of a rotation member of the attachment.

FIG. 8A is a perspective view of a second housing member, and FIG. 8B is a perspective view of a first housing member.

FIG. 9A is a sectional view taken along line I-I of FIG. 5, and FIG. 9B is a sectional view taken along line II-II of FIG. 5.

FIG. 10A is a sectional view taken along line III-III of in FIG. 5, and FIG. 10B is a sectional view taken along line IV-IV of FIG. 5.

FIG. 11 is a top plan view illustrating an upper wall of the housing member.

FIG. 12 is a bottom plan view of the attachment.

FIG. 13 is a top plan view illustrating the attachment in a positioning released state.

FIG. 14 is a top plan view illustrating the attachment in a positioning state.

### DESCRIPTION OF EMBODIMENTS

One embodiment of the invention will be described below with reference to the drawings.

In the following drawings, the dimensions may be scaled differently for each component for the purpose of clearly illustrating each component.

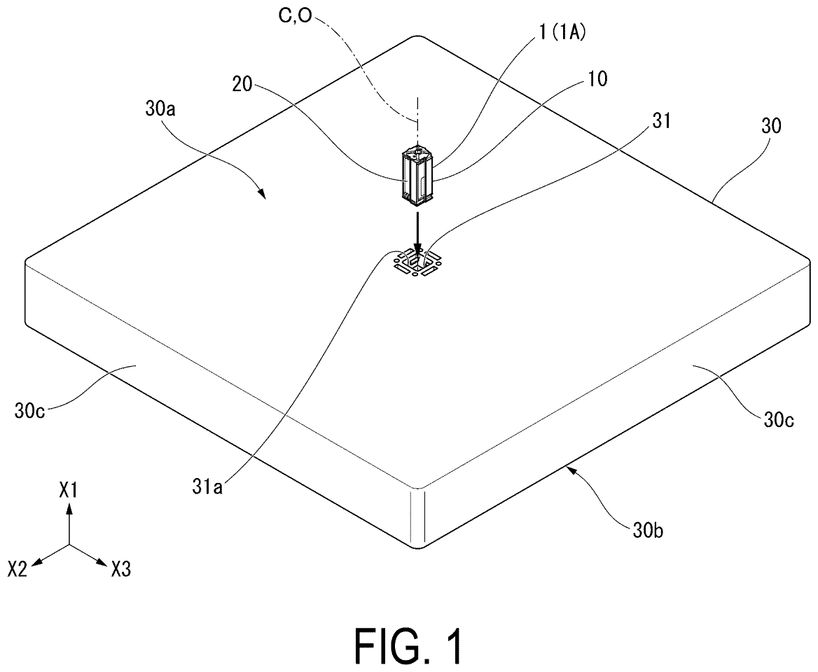

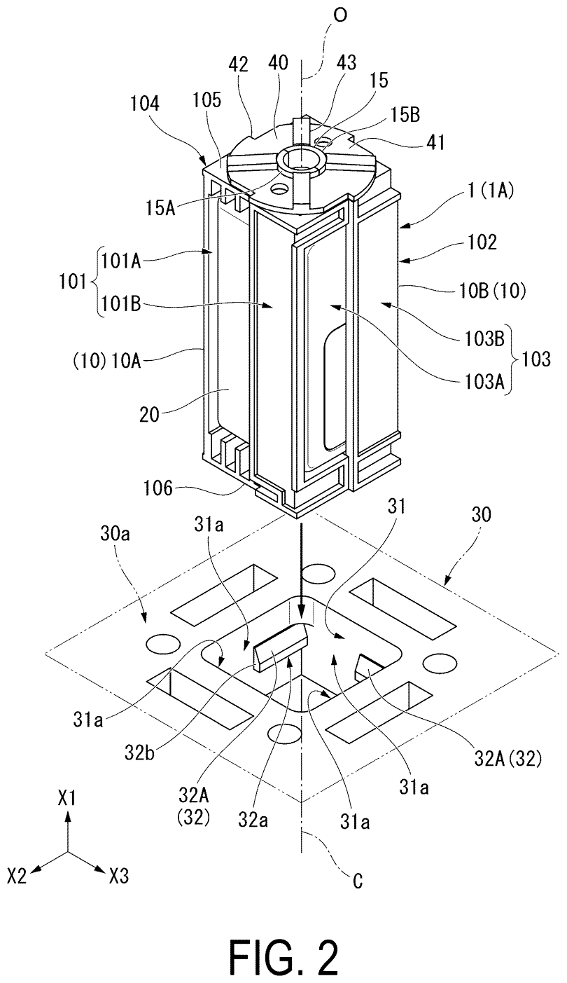

As illustrated in FIGS. 1 and 2, a pallet mounting GPS receiver attachment of the embodiment (hereinafter referred to as “attachment 1”) includes a housing member 10 to house a GPS receiver 20 to locate, based on a signal from a satellite, the position of a pallet 30 that is a material for logistics and includes a mounting surface 30a for mounting a load. The attachment 1 is detachably mounted to the mounting surface 30a of the pallet 30 in the state where the GPS receiver 20 is housed (a housing structure 1A). Specifically, the housing structure 1A is a structure in which the GPS receiver 20 is housed in the housing member 10 of the attachment 1.

The GPS receiver 20 includes an omnidirectional antenna for acquiring positioning information from a GPS (Global Positioning System). Note that while this embodiment describes an example in which a GPS antenna is adopted, other GNSS (Global Navigation Satellite System) antennas may be adopted instead of GPS antennas. In this embodiment, the GPS receiver 20 is composed of a columnar member with a substantially square cross-sectional shape. Note that the shape of the GPS receiver 20 may be a columnar shape, for example.

The pallet 30 is a plate-shaped member with a square shape in plan view. The opposite side of the mounting surface 30a of the pallet 30 is a bottom surface 30b. When placed with the mounting surface 30a of the pallet 30 facing up, the mounting surface 30a side is the upper side, and the bottom surface 30b side is the lower side.

As with common pallets, the pallet 30 is used for cargo-handling operation in factories, warehouses and the like. In a side surface 30c of the pallet 30, an opening (omitted in the drawing) into which the fork (omitted in the drawing) of the forklift is inserted in cargo-handling operation is provided.

At the center of the mounting surface 30a of the pallet 30, a mounting hole 31 for housing the attachment 1 is formed. The mounting hole 31 is an opening with substantially the same shape as the cross-sectional shape of the attachment 1 and with a square cross-sectional shape, and extends through the pallet 30 in its thickness direction. The attachment 1 (the housing structure 1A) is housed in the mounting hole 31 such that a central axis O (rotation axis) of the attachment 1 is coaxial with an opening center C of the mounting hole 31.

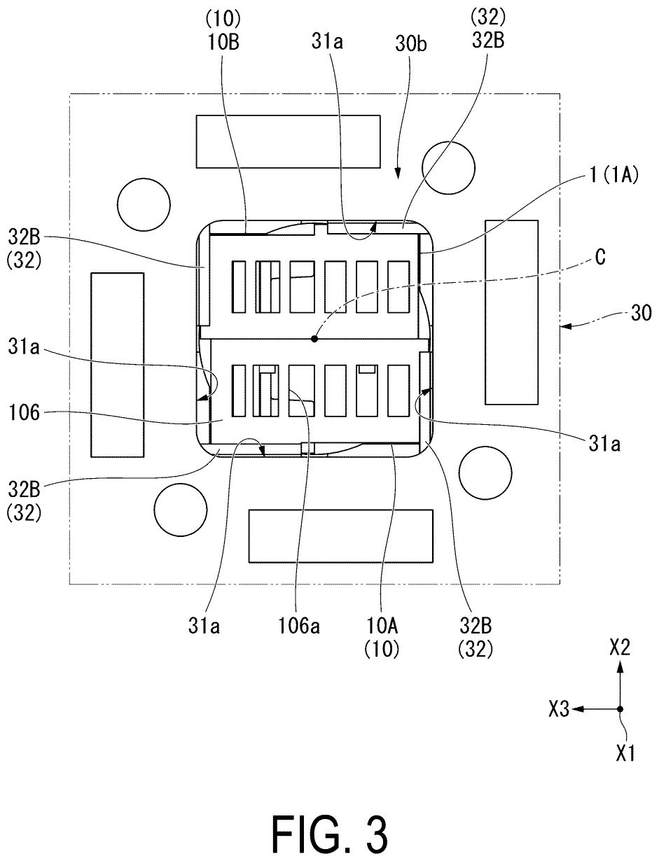

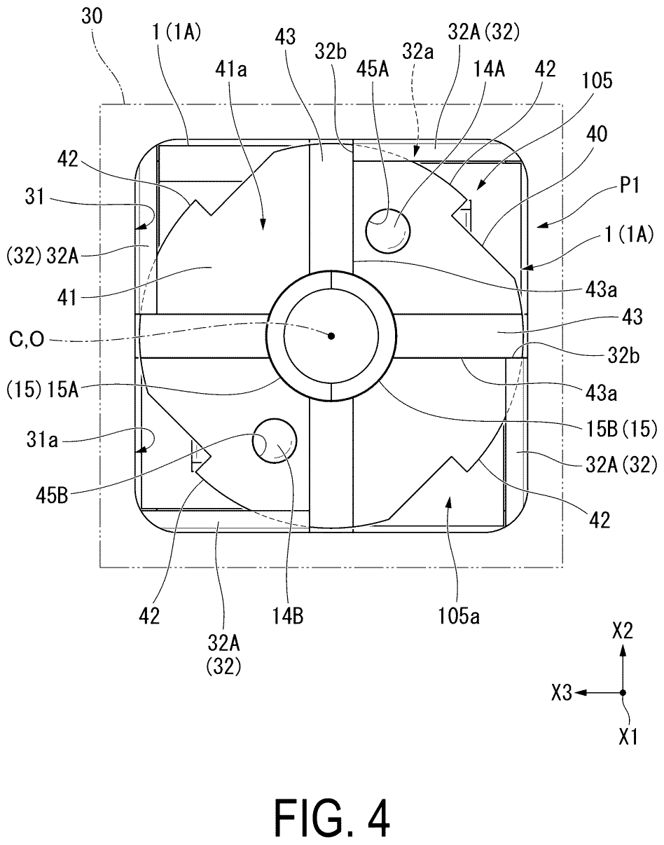

As illustrated in FIGS. 3 and 4, a protrusion 32 protruding inward of the mounting hole 31 is provided for each of four inner surfaces 31a of the mounting hole 31 of the pallet 30. Here, the planar shape of the inner surface 31a of the mounting hole 31 is a rectangular shape elongated along the opening center C. The protrusions 32 are disposed on the mounting surface 30a side and the bottom surface 30b side in each inner surface 31a. Here, the protrusion 32 disposed on the mounting surface 30a side is an upper protrusion 32A, and the protrusion 32 disposed on the bottom surface 30b side is a lower protrusion 32B. As viewed in the opening center C direction, the upper protrusion 32A and the lower protrusion 32B are disposed at different positions on the left and right side with respect to the center of the short direction (width direction) of each inner surface 31a. The lower protrusion 32B illustrated in FIG. 3 is a positioning member with which the bottom surface (lower wall 106) of the attachment 1 (the housing structure 1A) mounted in the mounting hole 31 makes contact, so as to restrict downward movement.

The protrusions 32A and 32B extend along the width direction of the inner surface 31a. The protruding heights of the protrusions 32A and 32B are substantially the same as the positions of the outer surfaces of first regions 101A, 102A, 103A and 104A of the housing member 10 described later. Specifically, they are set to dimensions with which the first regions 101A, 102A, 103A and 104A of the housing member 10 can pass through the protrusions 32A and 32B when the housing member 10 is inserted to or removed from the mounting hole 31.

An outer periphery protrusion 42 of a rotation member 40 described later in a positioning state P1 is located on the bottom surface 32a side of the upper protrusion 32A. At this time, with the upper protrusion 32A located on the upper side of the outer periphery protrusion 42, the upward movement of the attachment 1 is restricted, the position in the up-down direction X1 is set, and the attachment 1 is mounted without falling off. In addition, a lock protrusion 43 of the rotation member 40 described later in the positioning state P1 makes contact with a side surface 32b of the upper protrusion 32A.

As illustrated in FIGS. 1 and 2, the attachment 1 is configured to be insertable to and removable from the mounting hole 31 provided at the center of the top surface of the pallet 30 from the mounting surface 30a side.

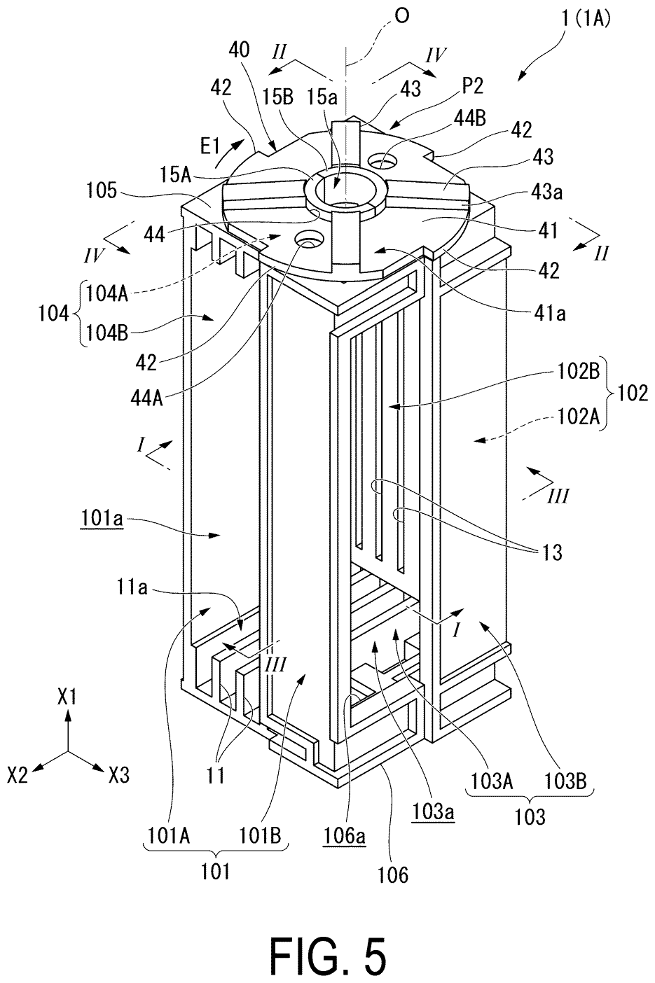

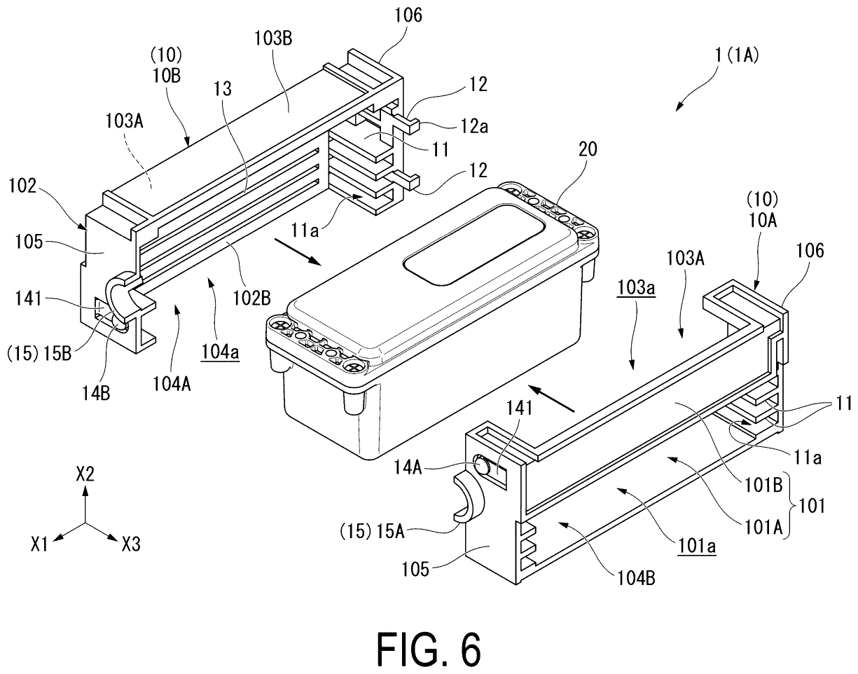

As illustrated in FIGS. 5 to 7, the attachment 1 includes a pair of the housing members 10 (10A, 10B) that houses the GPS receiver 20, and the rotation member 40 for fixing the housing member 10 housed in the mounting hole 31 of the pallet 30 to the mounting hole 31.

The housing member 10 has a substantially square-prism box shape whose entire outer hull has four side surfaces. The housing member 10 is a hollow member, and the GPS receiver 20 is housed inside in a fixed state. Specifically, the GPS receiver 20 is covered with the housing member 10.

Here, in the attachment 1, the direction along a central axis O extending in the longitudinal direction of the housing member 10 is the up-down direction X1 (first direction), and the two straight lines orthogonal to the up-down direction X1 are a front-rear direction X2 (second direction) and a left-right direction X3 (third direction). In addition, in the attachment 1, as viewed in the central axis O direction, the direction orthogonal to the central axis O is the radial direction, and the direction around the central axis O is the circumferential direction.

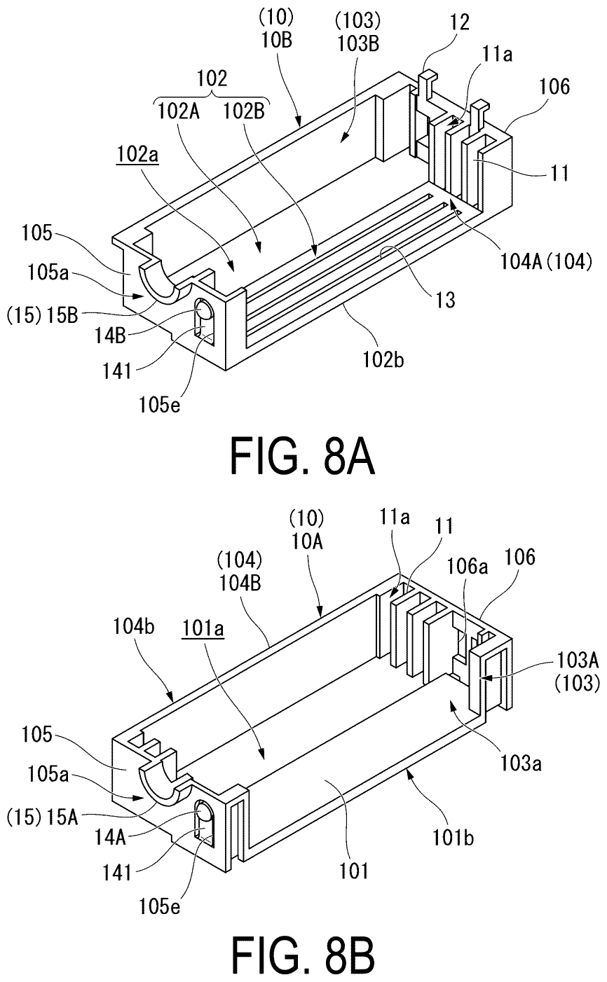

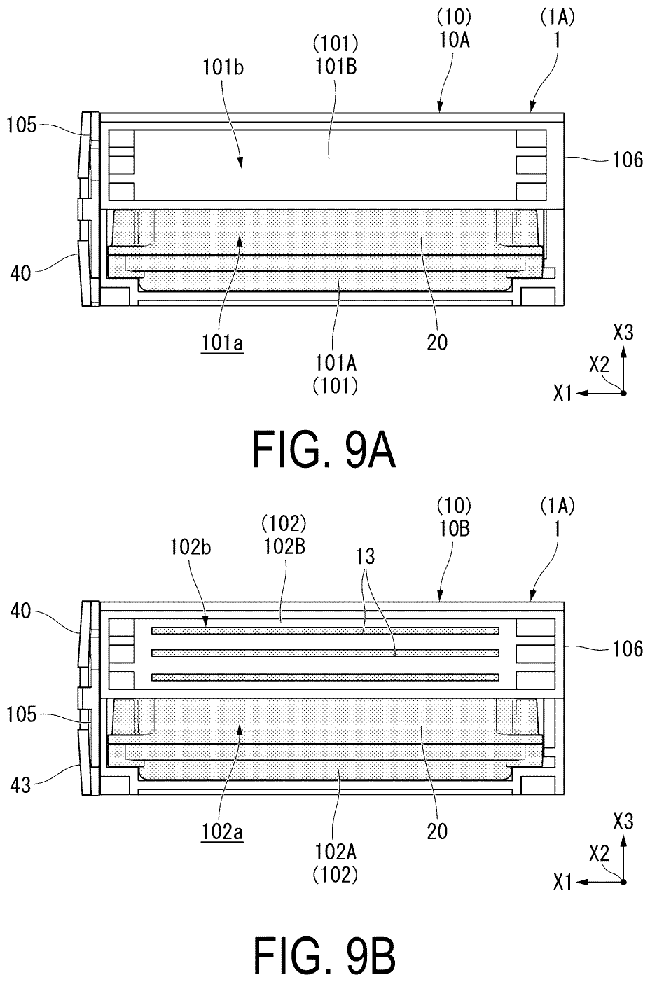

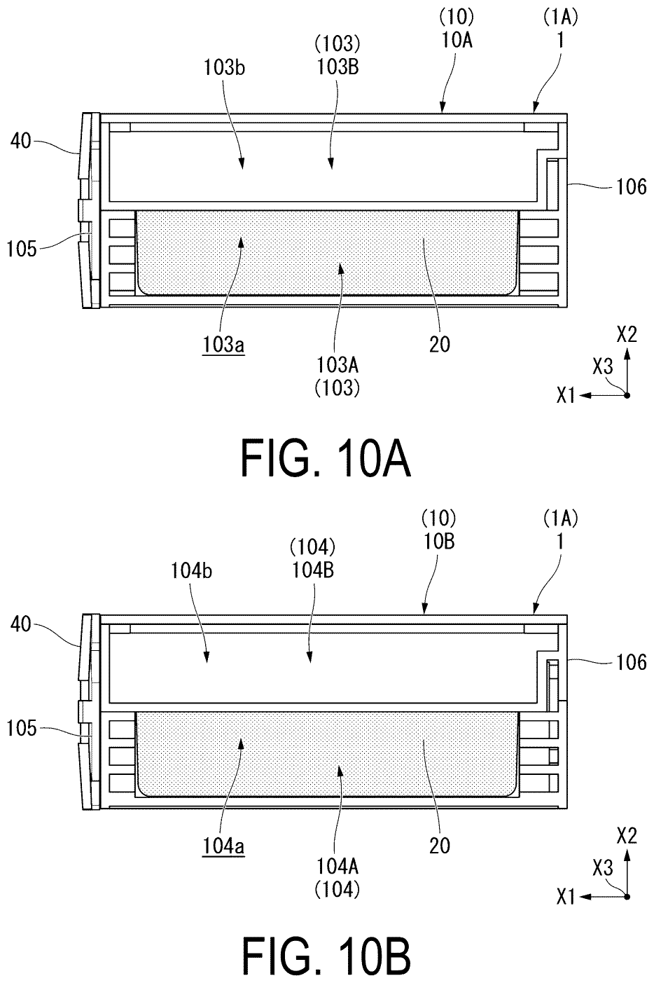

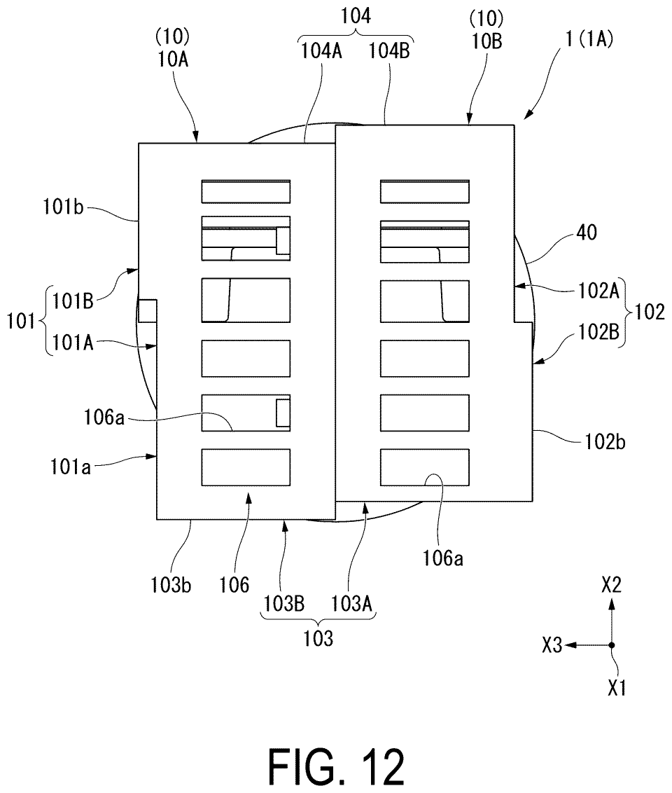

As illustrated in FIGS. 5 to 12, the housing member 10 includes a first housing member 10A and a second housing member 10B that can be separated to the front and rear sides at a middle position in the front-rear direction X2. In this embodiment, the side on which the first housing member 10A is located is the front side, and the side on which the second housing member 10B is located is the rear side. The GPS receiver 20 is housed in the housing member 10 with the pair of the first housing member 10A and the second housing member 10B fit to each other with the GPS receiver 20 sandwiched therebetween.

As illustrated in FIG. 2, the housing member 10 is inserted to the mounting hole 31 of the mounting surface 30a of the pallet 30 from the upper side so as to set the position of the GPS receiver 20 with respect to the pallet 30 in the front-rear direction X2 and left-right direction X3. The housing member 10 includes four side walls 101, 102, 103 and 104 surrounding the four sides, an upper wall 105 (first surface) that covers the upper opening of the cylindrical part surrounded by the four side walls 101, 102, 103 and 104, and a lower wall 106 (second surface) that covers the lower opening of the cylindrical part.

The side walls 101, 102, 103 and 104 include openings 101a, 102a, 103a and 104a, respectively. The upper wall 105 and the lower wall 106 include openings 105a and 106a, respectively. Specifically, the upper wall 105 including the upper opening (reference numerals 105c and 105d) and the lower wall 106 including the lower opening 106a face each other.

A plurality of protruding ribs 11 protruding upward is provided on the inner surfaces of the lower walls 106 of the first housing member 10A and the second housing member 10B. The plurality of protruding ribs 11 extends in one direction (in this case, the front-rear direction X2) and arranged in the left-right direction X3. Specifically, recessed groove 11a (recess) extending in the front-rear direction X2 is formed between the plurality of protruding ribs 11 adjacent to each other. The plurality of protruding ribs 11 of the first housing member 10A and the plurality of protruding ribs 11 of the second housing member 10B are located at the same positions in the left-right direction X3, and are linearly disposed over the front-rear direction X2 of the housing member 10. The plurality of protruding ribs 11 supports the GPS receiver 20 housed in the housing member 10 in the up-down direction X1, and sets the position in the up-down direction X1.

On the lower wall 106 of the second housing member 10B, a pair of engaging claws 12 (engaging portion) that engages with the lower opening 106a of the lower wall 106 of the second housing member 10B is provided. The pair of engaging claws 12 protrudes toward the first housing member 10A in the front-rear direction X2 of the second housing member 10B, and includes a claw portion 12a at the tip end portion. The claw portion 12a of the engaging claw 12 is engaged with an opening edge 106b of the lower opening 106a in the lower wall 106 of the first housing member 10A. When the engaging claw 12 engages with the lower opening 106a, the separated first housing member 10A and second housing member 10B are combined.

A first side wall 101 (first side surface) of the first housing member 10A includes a first region 101A on one side and a second region 101B on the other side with respect to the center portion of the left-right direction X3. The first region 101A includes a first opening 101a extending along the up-down direction X1. The second region 101B is closed and provided with no opening. The second side wall 102 (second side surface) facing the first side wall 101 of the second housing member 10B in the front-rear direction includes a first region 102A on one side and a second region 102B on the other side with respect to the center portion of the left-right direction X3. The first region 102A includes a second opening 102a extending along the up-down direction X1. The second region 102B is provided with no opening in its entirety, and is in a substantially closed state although a through groove 13 described later is formed therein.

The second region 102B in the second side wall 102 is disposed on the rear opposite side of the first region 101A in the first side wall 101. The first region 102A in the second side wall 102 is disposed on the rear opposite side of the second region 101B in the first side wall 101. Specifically, the first opening 101a of the first side wall 101 and the second opening 102a of the second side wall 102 are disposed in a shifted manner in the left-right direction X3.

In the second region 102B of the second side wall 102, a plurality of (in the drawing, three) through grooves 13 extending in the up-down direction X1 is formed. The through grooves 13 are arranged at an interval in the left-right direction X3, and extended through the second region 102B. Note that in this embodiment, the through groove 13 is not formed in the second region 101B of the first side wall 101, but the through groove 13 may be formed in the second region 101B as in the second side wall 102.

A third side wall 103 (third surface) provided across the first housing member 10A and the second housing member 10B includes a first region 103A on one side (in this case, the first housing member 10A side) and a second region 103B on the other side (in this case, the second housing member 10B side) with respect to the center portion of the front-rear direction X2. The first region 103A includes a third opening 103a extending along the up-down direction X1. The second region 103B is closed and provided with no opening. A fourth side wall 104 (fourth surface) provided across the first housing member 10A and the second housing member 10B and facing the third side wall 103 in the left-right direction X3 includes the first region 104A on one side (in this case, the second housing member 10B side) and a second region 104B on the other side (in this case, the first housing member 10A side) with respect to the center portion of the front-rear direction X2. The first region 104A includes a fourth opening 104a extending along the up-down direction X1. The second region 104B is closed and provided with no opening.

The second region 104B in the fourth side wall 104 is disposed on the opposite side of the first region 103A of the third side wall 103 in the left-right direction X3. The first region 104A in the fourth side wall 104 is disposed on the opposite side of the second region 103B of the third side wall 103 in the left-right direction X3. Specifically, the third opening 103a of the third side wall 103 and the fourth opening 104a of the fourth side wall 104 are disposed at positions shifted in the front-rear direction X3.

As viewed in the up-down direction X1, the second regions 101B, 102B, 103B and 104B in the side walls 101, 102, 103 and 104 are protruded to the outside relative to the outer surface positions of the first regions 101A, 102A, 103A and 104A, respectively. Therefore, in the state where the housing member 10 of the attachment 1 is inserted and housed in the mounting hole 31 of the pallet 30, the outermost periphery parts 101b, 102b, 103b and 104b of the second regions 101B, 102B, 103B and 104B are in contact with the inner surface 31a of the mounting hole 31. On the other hand, the outer surface positions of the first regions 101A, 102A, 103A and 104A are separated from the inner surface 31a of the mounting hole 31.

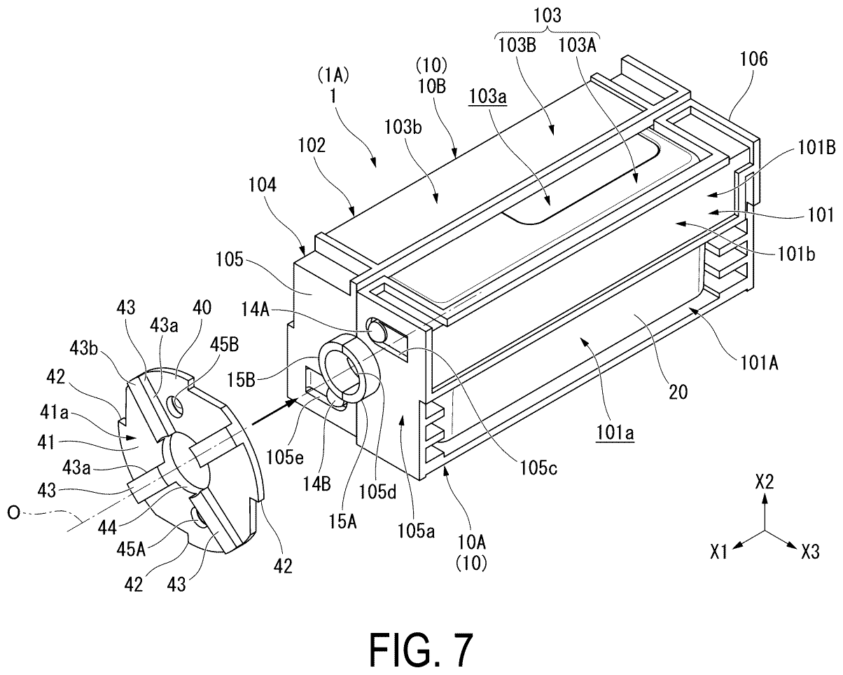

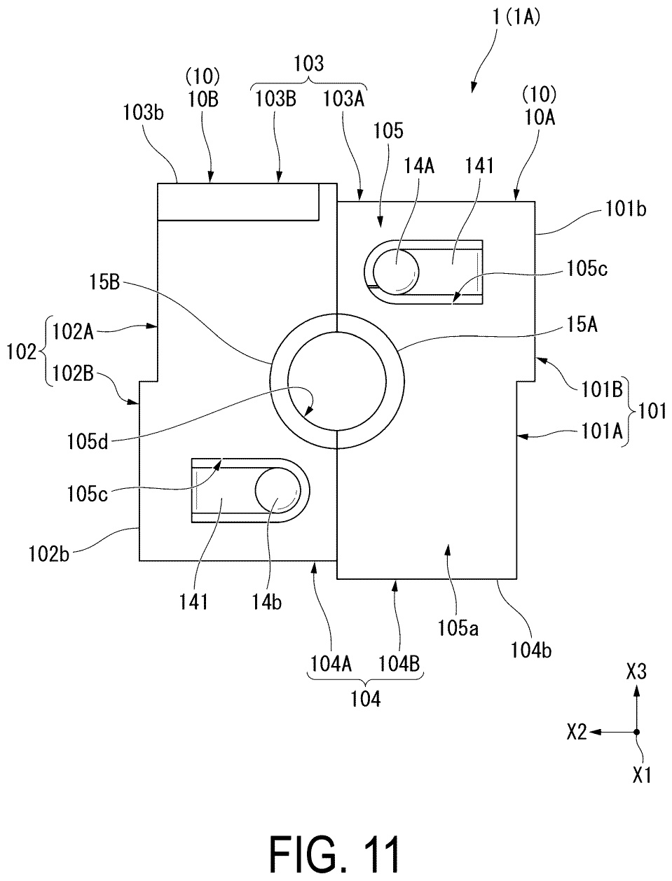

As illustrated in FIGS. 7 and 11, engaging cylindrical parts 15A and 15B with a cylindrical shape protruding upward are provided at a center portion of the upper wall 105 of the housing member 10. The engaging cylindrical parts 15A and 15B are formed in a cylindrical shape by combining the engaging cylindrical parts 15A and 15B with semicircular shapes in the first housing member 10A and the second housing member 10B.

The opening hole 105d communicating between the inside and outside of the housing member 10 is formed at the inner portion of the engaging cylindrical parts 15A and 15B in the upper wall 105. The protruding height of the engaging cylindrical parts 15A and 15B from a top surface 105a of the upper wall 105 is set to a height equal to or smaller than the height of the rotation member 40 described later. In this embodiment, the protruding height of the engaging cylindrical parts 15A and 15B is the same as the height of the rotation member 40. In addition, the outer diameter of the engaging cylindrical parts 15A and 15B is the same as the internal diameter of positioning holes 45A and 45B of the rotation member 40 described later.

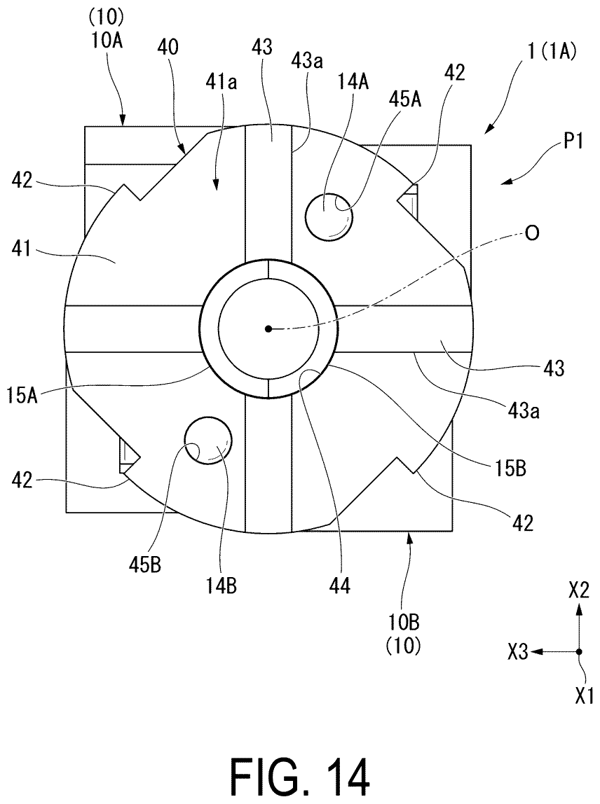

As illustrated in FIGS. 7, 11 and 14, positioning parts 14A and 14B protruding upward are provided in the upper walls 105 of the first housing member 10A and the second housing member 10B, respectively. The first positioning part 14A of the first housing member 10A and the second positioning part 14B of the second housing member 10B are provided in symmetric positions with respect to the central axis O of the attachment 1.

At least a part of the region around the positioning parts 14A and 14B in the upper wall 105 is open. In the upper wall 105, the penetration hole 105c configured to dispose the positioning parts 14A and 14B and extended through the upper wall 105 is formed. In the penetration hole 105c, an elastic piece 141 that is coupled to the inner edge of the penetration hole 105c and extended along the upper wall 105 is provided. The positioning parts 14A and 14B are provided at ends of the respective elastic pieces 141. Since the elastic piece 141 is coupled to the penetration hole 105c only at the base end portion, the positioning parts 14A and 14B can move up and down together with the elastic piece 141.

The positioning parts 14A and 14B restrict the rotation of the rotatable rotation member 40 described later at the upper wall 105 so as to set its rotation position. In this embodiment, when the rotation member 40 rotates in a first rotational direction E1 on one side and the positioning holes 45A and 45B described later fit to the pair of positioning parts 14A and 14B, the rotation of the rotation member 40 in the first rotational direction E1 is stopped.

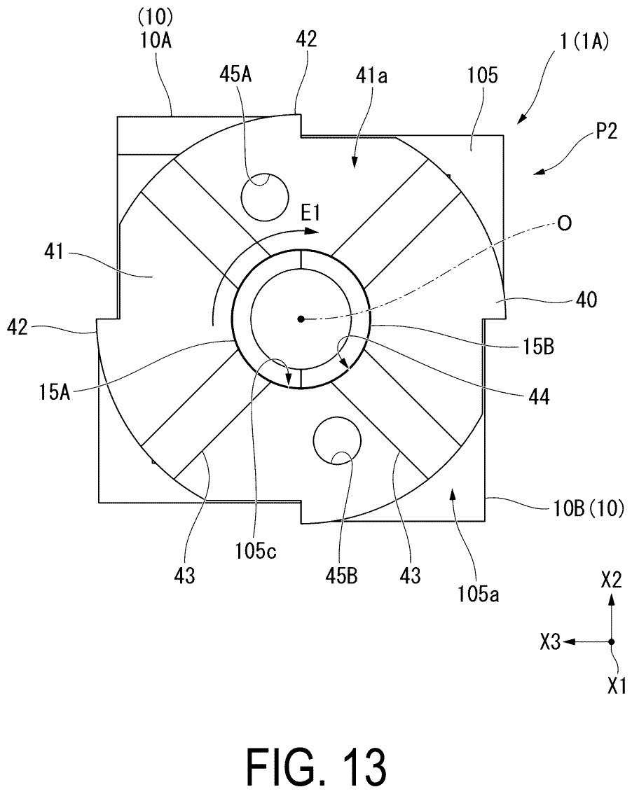

As illustrated in FIGS. 5, 7, 13, and 14, the rotation member 40 is supported at the upper wall 105 of the housing member 10 in a rotatable manner around the direction (the up-down direction X1) in which the housing member 10 is inserted to the mounting hole 31 provided in the mounting surface 30a of the pallet 30 illustrated in FIG. 2 as the rotation axis that is coaxial with the central axis O. The rotation member 40 sets the position of the GPS receiver 20 with respect to the pallet 30 in the up-down direction X1 through its rotation.

The rotation member 40 includes a rotation main body 41, the outer periphery protrusion 42, and the lock protrusion 43.

The rotation main body 41 has a plate shape with a substantially semicircular shape that is rotatable in the square cross section of the housing member 10 in top view. An engagement hole 44 that fits outside the engaging cylindrical parts 15A and 15B provided at the upper wall 105 of the housing member 10 is provided at the center of the rotation main body 41. A top surface 41a of the rotation main body 41 is formed in an inclined surface whose height gradually increases upward from the center side on the engagement hole 44 side toward the radially outside. Specifically, water such as rain water falling on the top surface 41a of the rotation main body 41 flows down into the housing member 10 from the engagement hole 44, and does not accumulate on the top surface 41a of the rotation main body 41.

The lock protrusion 43 has a ridge shape protruding upward from the top surface 41a of the rotation main body 41 and extending in the radial direction. The lock protrusion 43 also functions as an operation part for performing an operation of rotating the entire rotation member 40 around the central axis O by grabbing it by hand. Four lock protrusions 43 are disposed at a constant interval (in this case, 90° pitch) in the circumferential direction. The height of a top surface 43b of the lock protrusion 43 is the same as the position of the tip end of the engaging cylindrical part 15 in the state where the rotation member 40 is supported by the upper wall 105 of the housing member 10.

The rotation main body 41 is provided with a pair of the positioning holes 45A and 45B extending in the thickness direction. The paired positioning holes 45A and 45B can engage with the paired positioning parts 14A and 14B, respectively. In the state where the positioning parts 14A and 14B are engaged with the pair of the positioning holes 45 (the positioning state P1), the outer periphery protrusion 42 is positioned with respect to the pallet 30 in the up-down direction X1. In the positioning state P1, the first positioning hole 45A on one side engages with the first positioning part 14A provided at the upper wall 105 of the first housing member 10A. The second positioning hole 45B on the other side engages with the second positioning part 14B provided at the upper wall 105 of the second housing member 10B.

In the state where the positioning parts 14A and 14B do not engage with the pair of the positioning holes 45 (a positioning released state P2 illustrated in FIG. 5), the positioning in the up-down direction X1 of the outer periphery protrusion 42 with respect to the pallet 30 is released. In the positioning released state P2, the housing member 10 of the attachment 1 can move forward/backward with respect to the mounting hole 31 of the pallet 30 in the up-down direction X1, and the housing structure 1A can be attached to or detached from the mounting hole 31 of the pallet 30.

At the outer peripheral edge of the rotation member 40, four outer periphery protrusions 42 are provided at a constant interval (in this case, 90° pitch) in the circumferential direction. With the four outer periphery protrusions 42, the rotation member 40 has a windmill shape in its entirety. As illustrated in FIGS. 2 and 4, in the insertion direction in which the GPS receiver 20 is inserted to the mounting hole 31 of the pallet 30, the outer periphery protrusion 42 makes contact with the bottom surface 32a of the upper protrusion 32A of the pallet 30 in the insertion direction (the up-down direction X1) of the housing member 10 into the mounting hole 31. The outer periphery protrusion 42 sets the position of the housing structure 1A, that is, the position of the GPS receiver 20 housed in the attachment 1 in the up-down direction X1.

The outer periphery protrusion 42 is accommodated inside the outer periphery of the housing member 10 as viewed from the upper side in the state of the positioning released state P2 where the rotation position of the rotation member 40 is not set by the positioning parts 14A and 14B of the housing member 10.

With this outer periphery protrusion 42, the rotation member 40 can be selectively set to the position of the positioning state P1 and the position of the positioning released state P2 through the rotation of the rotation member 40 as illustrated in FIG. 4. In the positioning state P1 where the rotation position of the rotation member 40 is set by the positioning parts 14A and 14B of the housing member 10, the outer periphery protrusion 42 protrudes outward from the outer periphery of the first regions 101A, 102A, 103A and 104A of the housing member 10 as viewed from the upper side. When the attachment 1 is inserted to the mounting hole 31 of the pallet 30 and the rotation member 40 is set to the positioning state P1, the outer periphery protrusion 42 is located on the lower side of the upper protrusion 32A of the pallet 30. In this manner, with the upper protrusion 32A located on the upper side of the outer periphery protrusion 42, the upward movement of the attachment 1 is restricted, the position in the up-down direction X1 is set, and the attachment 1 is mounted without falling off.

Next, operational effects of the attachment 1 for pallet mounting are described.

As illustrated in FIG. 1, the attachment 1 of this embodiment includes the housing member 10 that houses the GPS receiver 20 to locate, based on a signal from a satellite, the position of the pallet 30 including the mounting surface 30a for mounting a load. The housing member 10 is inserted to the mounting hole 31 of the mounting surface 30a of the pallet 30 from one side toward the other side in the up-down direction X1, and sets the position of the GPS receiver 20 with respect to the pallet 30 in the front-rear direction X2 intersecting the up-down direction X1 and the left-right direction X3 intersecting the up-down direction X1 and front-rear direction X2. The housing member 10 includes the upper wall 105 that intersects the up-down direction X1 and includes the upper opening (reference numerals 105c and 10d), and the lower wall 106 that is opposite to the upper wall 105 in the up-down direction X1 and intersects the up-down direction X1. The lower wall 106 includes the lower opening 106a.

In this manner, in this embodiment, with the openings 105a and 106a provided in the upper wall 105 and the lower wall 106 of the housing member 10 of the attachment 1, even when the pallet 30 is placed outdoor and water enters the housing member 10, the water drains from the pallet 30 through the mounting hole 31 from the attachment 1. Thus, reduction in the intensity of the satellite signal received by the GPS receiver 20 due to accumulation of water on the upper and lower sides of the attachment 1 can be suppressed, and the GPS receiver 20 can stably receive the GPS radio waves.

In addition, in the attachment 1 of this embodiment, the housing member 10 includes the rotation member 40 that is supported at the upper wall 105 of the housing member 10 in a rotatable manner around the up-down direction X1, which is the direction in which the housing member 10 is inserted to the mounting hole 31 of the pallet 30, as the rotation axis. The position of the GPS receiver 20 with respect to the pallet 30 in the up-down direction X1 is set in accordance with the rotation position of the rotation member 40. With this simple configuration, by setting the rotation member 40 to a predetermined rotation position after inserting the housing member 10 to the mounting hole 31 of the pallet 30, the position of the housing member housing the GPS receiver 20 inside in the up-down direction X1 is set and fixed, and thus dropping of the attachment 1 from the pallet 30 can be suppressed.

In the attachment 1 of this embodiment, the housing member 10 includes the first housing member 10A and the second housing member 10B. The first housing member 10A and the second housing member 10B include a part of the upper opening 105a in the upper wall 105 and a part of the lower opening 106a in the lower wall 106, respectively. In this case, the water can efficiently drain from the upper opening 105a of the first housing member 10A and the lower opening 106a of the second housing member 10B.

According to the attachment 1 of this embodiment, the upper wall 105 of the first housing member 10A includes the first engaging cylindrical part 15A protruding to one side in the up-down direction X1. The upper wall 105 of the second housing member 10B includes the second engaging cylindrical part 15B protruding to one side in the up-down direction X1. The rotation member 40 fits to the first engaging cylindrical part 15A and the second engaging cylindrical part 15B in the state where the first housing member 10A and the second housing member 10B engage each other. In this manner, the rotation member 40 fits to the pair of engaging cylindrical parts 15A and 15B so as to be supported in a rotatable manner around the engaging cylindrical parts 15A and 15B, and thus the number of components, and the cost, can be reduced.

According to the attachment 1 of this embodiment, the height in the up-down direction X1 on one side in the rotation member 40 gradually increases from the outer periphery side of the rotation member 40 toward the rotation axis side. In this case, since the top surface of the rotation member 40 is tilted from the rotation axis side toward the outer circumference side, the water falling on the top surface of the rotation member 40 can be efficiently carried down to the outside of the attachment 1, and the accumulation of water on the top surface of the rotation member 40 can be suppressed.

According to the attachment 1 of this embodiment, the upper wall 105 is open in the region surrounded by the first engaging cylindrical part 15A and the second engaging cylindrical part 15B. In this case, the water can drain from the inside of the pair of engaging cylindrical parts 15A and 15B to the inside of the housing member 10, and the accumulation of water inside the engaging cylindrical parts 15A and 15B can be prevented.

According to the attachment 1 of this embodiment, the first positioning part 14A that sets the rotation position of the rotation member 40 is provided in the upper wall 105 of the first housing member 10A. The second positioning part 14B that sets the rotation position of the rotation member 40 is provided in the upper wall 105 of the second housing member 10. The rotation member 40 fits to the first positioning part 14A and the second positioning part 14B when rotated in one direction. In this case, since the rotation of the rotation member 40 fit to the pair of positioning parts 14A and 14B is restricted, it is possible to prevent the dropping of the attachment 1 from pallet 30 due to the rotation member 40 naturally turned by the vibration of the pallet 30 and the like with the attachment 1 mounted to the mounting hole 31 of the pallet 30, and release of the fixation state of the rotation member 40 and the pallet 30.

According to the attachment 1 of this embodiment, the first positioning part 14A and the second positioning part 14B are provided at symmetric positions with respect to the rotation axis (the central axis O). In this case, with the first positioning part 14A and the second positioning part 14B diagonally disposed, the positional displacement of the rotation member 40 after the rotation can be suppressed.

According to the attachment 1 of this embodiment, the upper wall 105 includes openings around the first positioning part 14A and the second positioning part 14B. In this case, the water can drain into the housing member 10 from the opening around each of the positioning parts 14A and 14B provided in the upper wall 105.

According to the attachment 1 of this embodiment, as viewed from one side in the up-down direction X1, the rotation member 40 is provided such that the positioning state P1 where it fits to the first positioning part 14A and the second positioning part 14B and the positioning released state P2 where it does not fit to the first positioning part 14A and the second positioning part 14B are selectable. The rotation member 40 includes the outer periphery protrusion 42 that is accommodated inside the outer periphery of the housing member 10 in the positioning released state P2, and is protruded from the outer periphery of the housing member 10 in the positioning state P1. The outer periphery protrusion 42 engages with the surface (the bottom surface 32a), of the protrusion 32 formed at the inner surface 31a of the mounting hole 31, on the other side in the up-down direction X1, with the housing member 10 inserted in the mounting hole 31 of the pallet 30. In this case, when the attachment 1 is inserted to the mounting hole 31, it can be inserted without interference of the rotation member 40 with the protrusion 32 of the mounting hole 31, and rotating the rotation member 40 causes the rotation member 40 and the protrusion 32 to overlap each other in the up-down direction X1 such that the movement in the insertion direction (the up-down direction X1) of the housing member 10 can be restricted.

According to the attachment 1 of this embodiment, the rotation member 40 includes the lock protrusion 43 that protrudes to the other side in the up-down direction X1. The lock protrusion 43 is away from the protrusion 32 of the pallet 30 in the rotational direction of the rotation member 40 when the rotation member 40 is in the positioning released state P2, and the lock protrusion 43 is in contact with the protrusion 32 in the rotational direction when the rotation member 40 is in the positioning state P1. In this case, since the rotation is restricted at the position where the lock protrusion 43 of the rotation member 40 is locked at the protrusion 32 of the pallet 30, the stop position of the rotation of the rotation member 40 can be set, thus suppressing excessive rotation.

According to the attachment 1 of this embodiment, the lower wall 106 is provided with the plurality of protruding ribs 11 that protrudes to one side in the up-down direction X1 and supports the GPS receiver 20 inside the housing member 10. An opening is provided between each of the plurality of protruding ribs 11. In this case, the GPS receiver 20 can be supported with respect to the housing member 10 with the plurality of protruding ribs 11 arranged at an interval. In this manner, the GPS receiver 20 can be disposed on the upper side of the lower opening 106a of the lower wall 106 with a space therebetween, and thus closing the lower opening 106a with the GPS receiver 20 can be suppressed.

According to the attachment 1 of this embodiment, the lower wall 106 of at least one of the first housing member 10 and the second housing member 10 includes the engaging claw 12 that engages with the lower opening 106a of the lower wall 106 on the other side. In this case, the pair of the first housing member 10A and the second housing member 10B can be engaged by a simple configuration of engaging the engaging claw 12 by using the lower opening 106a, and thus the number of components for housing the GPS receiver 20 can be reduced.

According to the attachment 1 of this embodiment, the housing member 10 includes the first side wall 101 formed in the first housing member 10A, and the second side wall 102 formed in the second housing member 10 and facing the first side wall 101. The first side wall 101 and the second side wall 102 respectively include the first regions 101A and 102A extending in the up-down direction X1 and including an opening, and the second regions 101B and 102B disposed adjacent to the first regions 101A and 102A in the direction orthogonal to the up-down direction X1 and extending in the up-down direction X1. In this case, the water coming from the upper wall 105 can drain to the lateral side of the housing member 10 from the openings of the first regions 101A and 102A of the first side wall 101 and the second side wall 102. Further, in this embodiment, since the openings are provided in the side surfaces of the housing members 10A and 10B, the reduction of the intensity of signals received from satellites can be suppressed unlike the case where the entire GPS receiver 20 is covered with the attachment 1.

According to the attachment 1 of this embodiment, the first region 101A of the first side wall 101 are disposed to face the second region 102B of the second side wall 102. The second region 101B of the first side wall 101 is disposed to face the first region 102A of the second side wall 102. In this case, the first region 102A of the second side wall 102 and the first region 101A of the first side wall 101 with the openings are disposed at shifted positions, and thus the water inside the housing member 10 can drain in a plurality of directions.

According to the attachment 1 of this embodiment, the second regions 101B and 102B include a plurality of the through grooves 13 with openings. Thus, the water inside the housing member 10 can drain not only from the first regions 101A and 102A with the openings but also from the second regions 101B and 102B through the through groove 13. In this case, the through groove 13 is additionally provided in the second regions 101B and 102B of the housing member 10, and thus the water can drain even when the pallet 30 is disposed upright.

According to the attachment 1 of this embodiment, the housing member 10 includes the third side wall 103 composed of the first housing member 10A and the second housing member 10B, and the fourth side wall 104 composed of the first housing member 10 and the second housing member 10 and disposed to face the third side wall 103. The third side wall 103 and the fourth side wall 104 include the first regions 103A and 104A, respectively extending in the up-down direction X1 and including openings, and the second regions 103B and 104B, respectively disposed adjacent to the first regions 103A and 104A in the direction orthogonal to the up-down direction X1 and extending in the up-down direction X1. In this case, the water coming from the upper wall 105 can drain from the openings of the first regions 103A and 104A of the third side wall 103 and the fourth side wall 104 to the lateral side of the housing member 10. Further, in this embodiment, since the openings are provided in the side surfaces of the housing members 10A and 10B, the reduction of the intensity of signals received from satellites can be suppressed unlike the case where the entire GPS receiver 20 is covered with the attachment 1.

According to the attachment 1 of this embodiment, the first region 103A of the third side wall 103 is disposed to face the second region 104B of the fourth side wall 104. The second region 103B of the third side wall 103 is disposed to face the first region 104A of the fourth side wall 104. In this case, the first region 104A of the fourth side wall 104 and the first region 103A of the third side wall 103 with openings are disposed at shifted positions, and thus the water inside the housing member 10 can drain in a plurality of directions.

According to the attachment 1 of this embodiment, as viewed in the up-down direction X1, the second regions 101B and 102B protrude to the outside relative to the first regions 101A and 102A. In this case, when the attachment 1 is inserted to the mounting hole 31 of the pallet 30, the second regions 101B and 102B of the housing members 10A and 10B make contact with the inner surface 31a of the mounting hole 31, and thus the position of the GPS receiver 20 in the front-rear direction X2 (second direction) and the left-right direction X3 (third direction) orthogonal to the first direction (the up-down direction X1) can be set.

According to the attachment 1 of this embodiment, as viewed in the up-down direction X1, the second regions 103B and 104B protrude to the outside relative to the first regions 103A and 104A. In this case, when the attachment 1 is inserted to the mounting hole 31 of the pallet 30, the second regions 103B and 104B of the housing members 10A and 10B make contact with the inner surface 31a of the mounting hole 31, thus the position of the GPS receiver 20 in the front-rear direction X2 (second direction) and the left-right direction X3 (third direction) orthogonal to the first direction (the up-down direction X1) can be set.

Some of the embodiments of the present disclosure are described above. However, those embodiments are given merely as examples, and are not intended to limit the scope of the present disclosure. Those embodiments can be carried out in various other forms, and various omission, replacement, and modifications may be made thereto without departing from the gist of the present disclosure. Those embodiments and the modifications thereof are within the scope and the gist of the present disclosure, and are also encompassed within the scope of claims and the scope of the equivalents in the present disclosure.

The pallet 30 has a rectangular plate-shape in the above-described embodiments, but the configuration of the pallet 30 is not limited to this.

The pallet mounting GPS receiver attachment according to one aspect of the present disclosure may have the following configurations.

A pallet mounting GPS receiver attachment according to one aspect of the present disclosure includes a housing member configured to house a GPS receiver configured to locate a position of a pallet based on a signal from a satellite, the pallet including a mounting surface for mounting a load, in which the housing member is inserted to a hole of the mounting surface of the pallet from one side toward the other side in a first direction, and sets a position of the GPS receiver with respect to the pallet in a second direction intersecting the first direction and in a third direction intersecting the first direction and the second direction, and the housing member includes a first surface intersecting the first direction and includes a first opening, and a second surface disposed on a side opposite to the first surface in the first direction, the second surface intersecting the first direction and including a second opening.

In the pallet mounting GPS receiver attachment according to one aspect of the present disclosure, the housing member includes a rotation member supported at the first surface of the housing member in a rotatable manner around the first direction as a rotation axis, the first direction being a direction in which the housing member is inserted to the hole of the pallet, and the position of the GPS receiver with respect to the pallet in the first direction is set in accordance with a rotation position of the rotation member.

In the pallet mounting GPS receiver attachment according to one aspect of the present disclosure, the housing member includes a first housing member and a second housing member, and each of the first housing member and the second housing member includes a part of the first opening in the first surface, and a part of the second opening in the second surface.

In the pallet mounting GPS receiver attachment according to one aspect of the present disclosure, the first surface of the first housing member includes a first protrusion part protruding to the one side in the first direction, the first surface of the second housing member includes a second protrusion part protruding to the one side in the first direction, and the rotation member fits to the first protrusion part and the second protrusion part in a state where the first housing member and the second housing member are engaged with each other.

In the pallet mounting GPS receiver attachment according to one aspect of the present disclosure, a height of the rotation member on the one side in the first direction gradually increases toward the rotation axis side from an outer periphery side of the rotation member.

In the pallet mounting GPS receiver attachment according to one aspect of the present disclosure, the first surface includes an opening in a region surrounded by the first protrusion part and the second protrusion part.

In the pallet mounting GPS receiver attachment according to one aspect of the present disclosure, the first surface of the first housing member includes a first positioning part configured to set the rotation position of the rotation member, the first surface of the second housing member includes a second positioning part configured to set the rotation position of the rotation member, and the rotation member fits to the first positioning part and the second positioning part when rotated in one direction.

In the pallet mounting GPS receiver attachment according to one aspect of the present disclosure, the first positioning part and the second positioning part are provided at symmetric positions with respect to the rotation axis.

In the pallet mounting GPS receiver attachment according to one aspect of the present disclosure, the first surface includes an opening around the first positioning part and the second positioning part.

In the pallet mounting GPS receiver attachment according to one aspect of the present disclosure, the rotation member is provided such that as viewed from the one side in the first direction a positioning state where the rotation member fits to the first positioning part and the second positioning part and a positioning released state where the rotation member does not fit to the first positioning part and the second positioning part are selectable, the rotation member includes an outer periphery protrusion configured to be accommodated inside an outer periphery of the housing member in the positioning released state and to protrude from the outer periphery of the housing member in the positioning state, and the outer periphery protrusion is locked to a surface on the other side in the first direction at a protrusion formed at an inner surface of the hole in a state where the housing member is inserted to the hole of the pallet.

In the pallet mounting GPS receiver attachment according to one aspect of the present disclosure, the rotation member includes a lock protrusion protruding to the other side in the first direction, the lock protrusion is separated from the protrusion of the pallet in a rotational direction of the rotation member when the rotation member is in the positioning released state, and the lock protrusion makes contact with the protrusion in the rotational direction when the rotation member is in the positioning state.

In the pallet mounting GPS receiver attachment according to one aspect of the present disclosure, the second surface includes a plurality of protruding ribs protruding to the one side in the first direction, and configured to support the GPS receiver inside the housing member, and an opening is provided between each of the plurality of protruding ribs.

In the pallet mounting GPS receiver attachment according to one aspect of the present disclosure, the second surface of at least one of the first housing member and the second housing member includes an engaging portion configured to engage with the second opening of the second surface of the other of the first housing member and the second housing member.

In the pallet mounting GPS receiver attachment according to one aspect of the present disclosure, the housing member includes a first side surface formed in the first housing member, and a second side surface formed in the second housing member and disposed to face the first side surface, and each of the first side surface and the second side surface includes a first region extending in the first direction and including an opening, and a second region disposed adjacent to the first region in a direction orthogonal to the first direction and extending in the first direction.

In the pallet mounting GPS receiver attachment according to one aspect of the present disclosure, the first region of the first side surface is disposed to face the second region of the second side surface, and the second region of the first side surface is disposed to face the first region of the second side surface.

In the pallet mounting GPS receiver attachment according to one aspect of the present disclosure, the second region includes a plurality of grooves with openings.

In the pallet mounting GPS receiver attachment according to one aspect of the present disclosure, the housing member includes a third side surface formed of the first housing member and the second housing member, and a fourth side surface formed of the first housing member and the second housing member and disposed to face the third side surface, and each of the third side surface and the fourth side surface includes a first region extending in the first direction and including an opening, and a second region disposed adjacent to the first region in a direction orthogonal to the first direction and extending in the first direction.

In the pallet mounting GPS receiver attachment according to one aspect of the present disclosure, the first region of the third side surface is disposed to face the second region of the fourth side surface, and the second region of the third side surface is disposed to face the first region of the fourth side surface.

In the pallet mounting GPS receiver attachment according to one aspect of the present disclosure, as viewed in the first direction, the second region is protruded to outside relative to the first region.

In the pallet mounting GPS receiver attachment according to one aspect of the present disclosure, as viewed in the first direction, the second region is protruded to outside relative to the first region. In the pallet mounting GPS receiver attachment according to one aspect of the present disclosure, as viewed in the first direction, the second region is protruded to outside relative to the first region.

What is claimed is:

1. A pallet mounting GPS receiver attachment comprising a housing member configured to house a GPS receiver configured to locate a position of a pallet based on a signal from a satellite, the pallet including a mounting surface for mounting a load, wherein
the housing member is inserted to a hole of the mounting surface of the pallet from one side toward the other side in a first direction, and sets a position of the GPS receiver with respect to the pallet in a second direction intersecting the first direction and in a third direction intersecting the first direction and the second direction, and
the housing member includes:
a first surface intersecting the first direction and includes a first opening, and
a second surface disposed on a side opposite to the first surface in the first direction, the second surface intersecting the first direction and including a second opening.

2. The pallet mounting GPS receiver attachment according to claim 1, wherein
the housing member includes a rotation member supported at the first surface of the housing member in a rotatable manner around the first direction as a rotation axis, the first direction being a direction in which the housing member is inserted to the hole of the pallet, and
the position of the GPS receiver with respect to the pallet in the first direction is set in accordance with a rotation position of the rotation member.

3. The pallet mounting GPS receiver attachment according to claim 2, wherein
the housing member includes a first housing member and a second housing member, and
each of the first housing member and the second housing member includes a part of the first opening in the first surface, and a part of the second opening in the second surface.

4. The pallet mounting GPS receiver attachment according to claim 3, wherein
the first surface of the first housing member includes a first protrusion part protruding to the one side in the first direction,
the first surface of the second housing member includes a second protrusion part protruding to the one side in the first direction, and
the rotation member fits to the first protrusion part and the second protrusion part in a state where the first housing member and the second housing member are engaged with each other.

5. The pallet mounting GPS receiver attachment according to claim 4, wherein a height of the rotation member on the one side in the first direction gradually increases toward the rotation axis side from an outer periphery side of the rotation member.

6. The pallet mounting GPS receiver attachment according to claim 4, wherein the first surface includes an opening in a region surrounded by the first protrusion part and the second protrusion part.

7. The pallet mounting GPS receiver attachment according to claim 3, wherein
the first surface of the first housing member includes a first positioning part configured to set the rotation position of the rotation member,
the first surface of the second housing member includes a second positioning part configured to set the rotation position of the rotation member, and
the rotation member fits to the first positioning part and the second positioning part when rotated in one direction.

8. The pallet mounting GPS receiver attachment according to claim 7, wherein the first positioning part and the second positioning part are provided at symmetric positions with respect to the rotation axis.

9. The pallet mounting GPS receiver attachment according to claim 7, wherein the first surface includes an opening around the first positioning part and the second positioning part.

10. The pallet mounting GPS receiver attachment according to claim 7, wherein
the rotation member is provided such that as viewed from the one side in the first direction a positioning state where the rotation member fits to the first positioning part and the second positioning part and a positioning released state where the rotation member does not fit to the first positioning part and the second positioning part are selectable,
the rotation member includes an outer periphery protrusion configured to be accommodated inside an outer periphery of the housing member in the positioning released state and to protrude from the outer periphery of the housing member in the positioning state, and
the outer periphery protrusion is locked to a surface on the other side in the first direction at a protrusion formed at an inner surface of the hole in a state where the housing member is inserted to the hole of the pallet.

11. The pallet mounting GPS receiver attachment according to claim 10, wherein
the rotation member includes a lock protrusion protruding to the other side in the first direction,
the lock protrusion is separated from the protrusion of the pallet in a rotational direction of the rotation member when the rotation member is in the positioning released state, and
the lock protrusion makes contact with the protrusion in the rotational direction when the rotation member is in the positioning state.

12. The pallet mounting GPS receiver attachment according to claim 1, wherein
the second surface includes a plurality of protruding ribs protruding to the one side in the first direction, and configured to support the GPS receiver inside the housing member, and
an opening is provided between each of the plurality of protruding ribs.

13. The pallet mounting GPS receiver attachment according to claim 3, wherein the second surface of at least one of the first housing member and the second housing member includes an engaging portion configured to engage with the second opening of the second surface of the other of the first housing member and the second housing member.

14. The pallet mounting GPS receiver attachment according to claim 3, wherein
the housing member includes:
a first side surface formed in the first housing member, and
a second side surface formed in the second housing member and disposed to face the first side surface, and
each of the first side surface and the second side surface includes:
a first region extending in the first direction and including an opening, and
a second region disposed adjacent to the first region in a direction orthogonal to the first direction and extending in the first direction.

15. The pallet mounting GPS receiver attachment according to claim 14, wherein
the first region of the first side surface is disposed to face the second region of the second side surface, and
the second region of the first side surface is disposed to face the first region of the second side surface.

16. The pallet mounting GPS receiver attachment according to claim 14, wherein the second region includes a plurality of grooves with openings.

17. The pallet mounting GPS receiver attachment according to claim 3, wherein
the housing member includes:
a third side surface formed of the first housing member and the second housing member, and
a fourth side surface formed of the first housing member and the second housing member and disposed to face the third side surface, and
each of the third side surface and the fourth side surface includes:
a first region extending in the first direction and including an opening, and
a second region disposed adjacent to the first region in a direction orthogonal to the first direction and extending in the first direction.

18. The pallet mounting GPS receiver attachment according to claim 17, wherein
the first region of the third side surface is disposed to face the second region of the fourth side surface, and
the second region of the third side surface is disposed to face the first region of the fourth side surface.

19. The pallet mounting GPS receiver attachment according to claim 15, wherein as viewed in the first direction, the second region is protruded to outside relative to the first region.

20. The pallet mounting GPS receiver attachment according to claim 17, wherein as viewed in the first direction, the second region is protruded to outside relative to the first region.
